(19) United States
(12) Patent Application Publication
(10) Pub. No.: US 2022/0121787 A1
(43) Pub. Date: Apr. 21, 2022

(54) METHOD FOR COMPONENT-LEVEL NON-ITERATIVE CONSTRUCTION OF AIRBORNE REAL-TIME MODEL OF VARIABLE-CYCLE ENGINE

(71) Applicant: NANJING UNIVERSITY OF AERONAUTICS AND ASTRONAUTICS, Jiangsu (CN)

(72) Inventors: Feng LU, Jiangsu (CN); Zhihu LI, Jiangsu (CN); Jinquan HUANG, Jiangsu (CN); Wenxiang ZHOU, Jiangsu (CN); Xunkai WEI, Jiangsu (CN)

(73) Assignee: NANJING UNIVERSITY OF AERONAUTICS AND ASTRONAUTICS, Jiangsu (CN)

(21) Appl. No.: 17/312,396

(22) PCT Filed: Jan. 7, 2021
(86) PCT No.: PCT/CN2021/070665

§ 371 Date: Jun. 10, 2021

(30) Foreign Application Priority Data
May 7, 2020 (CN) 202010374999.1

(51) Int. Cl. G06F 30/17; G06F 111/10

(52) U.S. Cl. CPC G06F 30/17; G06F 2111/10

(57) ABSTRACT

The present invention discloses a method for component-level non-iterative construction of an airborne real-time model of a variable-cycle engine, which is proposed by using an existing nonlinear component-level dynamic general model of a variable-cycle engine in combination with a modeling idea of an aero-engine LPV model. In the original nonlinear component-level general model of the variable-cycle engine, components are connected together through a system of nonlinear co-working equations, and characteristic parameters of the respective components are obtained by iteratively solving the system of nonlinear co-working equations. In such a process of iteratively solving the system of nonlinear equations, much time is taken to operate the model. In the component-level non-iterative method for the variable-cycle engine, an LPV model replaces such a process of iteratively solving the system of nonlinear equations, and can significantly reduce the time taken by and increase the real-time performance of a model of the variable-cycle engine.

### TECHNICAL FIELD

The present invention relates to the field of modeling and simulation of aero-engines, and in particular, relates to a method or component-level non-iterative construction of an airborne real-time model of a variable-cycle engine.

### BACKGROUND

Due to adjustable geometric components, variable-cycle engines can change their thermal cycle under different flight conditions to achieve the best flight performance. A double-bypass variable-cycle engine with a basic structure shown as in FIG. 1 mainly has two typical operating modes.

In a single-bypass mode, a mode selection valve is closed, and the areas of front and rear variable area bypass injectors (VABIs) are down regulated, so that almost all the air flowing through a front fan flows through a core drive fan and a high-pressure air compressor, allowing only a small part of the flow to pass through a bypass to cool an exhaust nozzle. At this point, the engine reaches the maximum specific thrust to meet the thrust requirement of an aircraft during taking-off, climbing or supersonic flight.

In a double-bypass mode, the mode selection valve is open, and the areas of front and rear variable area bypass injectors are up regulated, so that the air flow of the front fan is increased, allowing part of the air flowing through a core drive fan stage (CDFS) to flow into a main bypass from a CDFS bypass, and the other part to flow into the air compressor. At this point, the engine reaches the maximum bypass ratio, which can reduce the fuel consumption rate to adapt to the subsonic flight.

The variable-cycle engine operates in a harsh operating environment and has a more complex structure as compared with conventional engines. It has very high requirements on safety and reliability. The control system design, fault diagnosis, and analytic redundancy of an aero-engine depend on an aero-engine model, and both the accuracy of the engine and the real-time performance of the engine model must be considered in airborne applications.

At present, there are two mainstream simulation models for the variable-cycle engine, including a nonlinear component-level model (NCLM) and a linear state variable model. The nonlinear component-level model, as established based on the principle of engine aerodynamics and thermodynamics by using an analytical method, is high in accuracy and large in the range of adaptation, but low in real-time performance. An engine state variable model is a state variable model of an input-output relationship of the engine as established by performing linearization on a certain steady-state point based on the nonlinear component-level model of the engine, and a large number of state variable models make up an engine LPV model. The linear model has low computing capacity and good real-time performance, but errors may occur during secondary modeling. The present invention proposes a method for component-level non-iterative construction of an airborne real-time model of a variable-cycle engine by combining a nonlinear component-level general model of a variable-cycle engine with a traditional LPV modeling method and by using individual component models of the variable-cycle engine and an LPV model of the speed and pressure ratio, and the method may increase the real-time performance of the engine model with low accuracy loss.

### SUMMARY OF THE INVENTION

The technical problem to be solved by the present invention is to provide a variable-cycle engine model with high real-time performance and high accuracy in light of the defect in the background art, aiming to solve the problems that the original nonlinear component-level model is inadequate in real-time performance and the linear model has large errors.

To solve the technical problem above, the present invention employs a technical solution including the following steps.

Step A) solving state parameters such as speed and pressure ratio of the engine by designing a non-iterative solving algorithm for a system of nonlinear co-working equations in a linear parameter varying (LPV) form based on a component-level model of a variable-cycle engine, wherein a matching relationship of a system of rotor acceleration equations is established by using an LPV state transition equation, and a component-level flow rate balance relationship is established by using a system of LPV output equations; and

Step B) establishing a component-level non-iterative on-board real-time model of the variable-cycle engine by constructing relationships among component parameters of the variable-cycle engine in a single-bypass mode and a double-bypass mode by using an LPV non-iterative solving method, respectively, wherein an inertia element of output parameters is introduced during switching between the single-bypass mode and the double-bypass mode, and an A8 variable polycell method is used in different modes.

As a further optimized solution to the method for component-level non-iterative construction of the airborne real-time model of the variable-cycle engine according to the present invention, step A) specifically includes the following steps:

A1) solving matrix coefficients of a state variable model for the speed and pressure ratio of the variable-cycle engine in different states, to make up an LPV model for the speed and pressure ratio;

A2) building the matching relationship in the system of the rotor acceleration equations of the engine by using the state transition equation in the LPV model, and building a balance relationship between a flow rate and a pressure by using a system of output parameter equations; and

A3) finding a non-iterative solution to the system of the nonlinear co-working equations for the speed and the pressure ratio by the LPV model.

As a further optimized solution to the method for component-level non-iterative construction of the airborne real-time model of the variable-cycle engine according to the present invention, step B) specifically comprises the following steps:

B1) constructing the component-level non-iterative model in the single-bypass mode and the double-bypass mode by combining an existing engine component model with the established model in the LPV form;

B2) introducing the inertia element of the output parameters during the switching of the modes to reduce output errors of the model during the switching between the single-bypass mode and the double-bypass mode; and

B3) determining a corresponding form of the LPV model based on an operating mode of the variable-cycle engine and scheduling system parameters in the LPV form with the A8 variable polycell method, thereby implementing non-iterative computation for the airborne real-time model of the variable-cycle engine in different modes.

Compared with the prior art, the technical solutions used in the present invention have the following technical effects:

The present invention provides a method for component-level non-iterative construction of an airborne real-time model of a variable-cycle engine, wherein respective component models are retained on the basis of a nonlinear component-level general model, an LPV modeling idea is combined, and an LPV model for the speed and pressure ratio is used to replace an original process of iteratively solving nonlinear co-working equations by an nonlinear component-level model, thereby avoiding an iterative process; and the model according to the present invention has higher real-time performance than that of the traditional nonlinear component-level model and higher accuracy than that of the linear state variable model, which is conducive to practical engineering applications.

### BRIEF DESCRIPTION OF THE DRAWINGS

FIG. 1 is a schematic diagram of a component-level non-iterative model.

FIG. 2 is a numbered sectional view of a variable-cycle engine.

FIG. 3 is a flight trajectory diagram with an engine within an envelope.

FIG. 4 is a normalized variation diagram of a fuel flow rate Wf and an exhaust-nozzle throat area A8 of an engine.

FIGS. 5-9 are diagrams showing simulation comparisons between a nonlinear component-level model and a component-level non-iterative model with respect to the output parameters NL, NH, T21, P21, T15, P15, T3, P3, T5 and P5 of an engine.

FIG. 10 shows tracking errors of the output parameters of the engine.

FIG. 11 shows a comparison of simulation time consumption between a nonlinear component-level model and a component-level non-iterative model.

### DETAILED DESCRIPTION OF THE INVENTION

The concept of the present invention is to improve and develop an existing aero-engine simulation model with respect to the requirements of an advanced aero-engine for the real-time performance and accuracy of an airborne model, and establish an airborne real-time component-level non-iterative model of a variable-cycle engine above an idle state, which can significantly increase the real-time performance of the engine model with low accuracy loss.

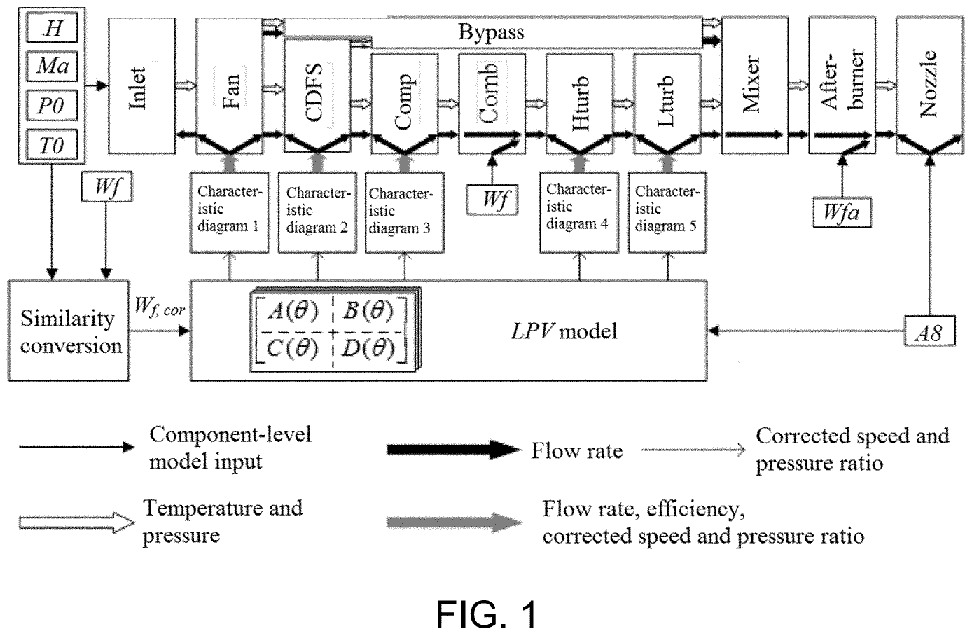

The present invention is specifically implemented by taking the construction of a component-level non-iterative real-time model of a certain type of double-bypass variable-cycle engine as an example. FIG. 1 is a schematic diagram of a component-level non-iterative real-time model of a variable-cycle engine. Such a simulation model is established by the following steps:

In step A), state parameters such as speed and pressure ratio of the engine are solved by designing a non-iterative solving algorithm for a system of nonlinear co-working equations in an LPV form based on a component-level model of a variable-cycle engine, wherein a matching relationship of a system of rotor acceleration equations is established by using an LPV state transition equation, and a component-level flow rate balance relationship is established by using a system of LPV output equations.

In step B), a component-level non-iterative on-board real-time model of the variable-cycle engine is established by constructing relationships among component parameters of the variable-cycle engine in a single-bypass mode and a double-bypass mode respectively, wherein an inertia element of output parameters is introduced during switching between the single-bypass mode and the double-bypass mode, and an A8 variable polycell method is used in different modes.

Furthermore, step A) includes the following steps in detail.

In step A1), matrix coefficients of a state variable model for the speed and pressure ratio of the variable-cycle engine in different states are solved by using a small perturbation method, to make up an LPV model for the speed and pressure ratio.

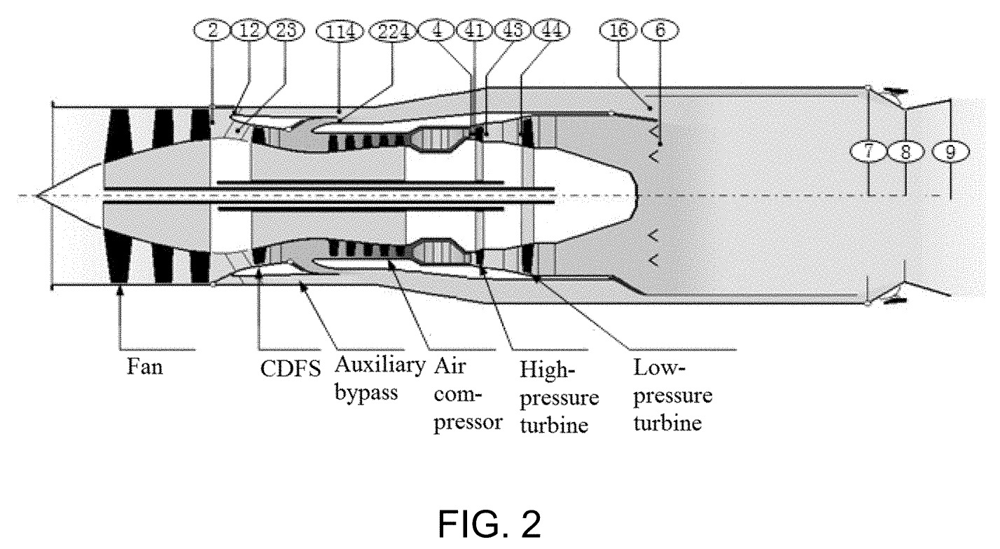

Co-working equations of the component-level model of the variable cycle engine are the following:

$$\begin{matrix}\{ \begin{matrix}( Single \text{-} bypass mode ) {e}_{1} = \frac{( {W}_{a 12} + {W}_{a 23} )}{{W}_{a 2} - 1} \\ ( Double \text{-} bypass mode ) {e}_{1} = \frac{{P}_{s 114}}{{P}_{s 224} - 1}\end{matrix} & ( 1 ) \\ {e}_{2} = \frac{{W}_{g 41}}{{W}_{g 4} - 1} & ( 2 ) \\ {e}_{3} = \frac{{W}_{g 44}}{{W}_{g 43} - 1} & ( 3 ) \\ {e}_{4} = \frac{{W}_{g 9}}{{W}_{g 7} - 1} & ( 4 ) \\ {e}_{5} = \frac{{P}_{s 16}}{{P}_{s 6} - 1} & ( 5 ) \\ \frac{{dn}_{L}}{dt} = \frac{900 ( {N}_{LT} {η}_{L} - {N}_{F} )}{{π}^{2} {J}_{L} {n}_{L}} & ( 6 ) \\ \frac{{dn}_{H}}{dt} = \frac{900 ( {N}_{HT} {η}_{H} - {N}_{ex} - {N}_{C} )}{{π}^{2} {J}_{H} {n}_{H}} , & ( 7 )\end{matrix}$$

wherein e represents a residual, W represents a flow rate, P represents a pressure, N represents a power, n represents a speed, η represents efficiency, J represents a moment of inertia, t represents time, and π here represents the ratio of the circumference to the diameter of the circle which is a constant. Among W, P, n, N, η and J, the subscript a represents air, the subscript g represents gas (a mixture of air and fuel), the subscript s represents a static pressure, the subscript L represents a low-pressure rotor, the subscript H represents a high-pressure rotor, the subscript F represents a fan, the subscript C represents an air compressor, the subscript LT represents a low-pressure turbine, the subscript HT represents a high-pressure turbine, the subscript ex represents other power-consuming accessories, and subscripts 12, 23, 2, 114, 224, 4, 41, 43, 44, 7, 9, 16 and 6 respectively represent different section positions of an engine, as shown in FIG. 2. After the engine enters a steady state, a sum of rotor rotary accelerations

$$\frac{{dn}_{L}}{dt} and \frac{{dn}_{H}}{dt}$$

is zero, that is, a power balance is achieved. Therefore, the steady state of the engine is a special case of dynamics, and the dynamics are more general.

After input conditions of the component-level model are introduced, equation (1) to equation (7) may be written as the following:

$$\{ \begin{matrix}\dot{n} = f ( u , π , n ) \\ e = g ( u , π , n )\end{matrix} , \qquad ( 8 )$$

wherein u indicates an input of the component-level model, n=[n_{L},n_{H}]^{T} indicates a rotor speed, π=[π₁, π₂, π₃, π₄, π₅]^{T} indicates pressure ratios among five rotating components including the fan, CDFS, air compressor, high-pressure turbine, and low-pressure turbine, and e=[e₁, e₂, e₃, e₄, e₅]^{T} indicates a residual.

$$\{ \begin{matrix}\dot{n} = f ( u , π , n ) \\ e = g ( u , π , n )\end{matrix} {\to }^{iterative convergence} \{ \begin{matrix}\dot{n} = f ( u , π , n ) \\ 0 \approx g ( u , π , n )\end{matrix} \qquad ( 9 )$$

From the equation (9), the expression of the pressure ratio π may be obtained as below:

$$π {=}^{Δ} {g}_{1} ( u , n ) . \qquad ( 10 )$$

Insert equation (10) into equation (9), we obtain

$$\dot{n} = f ( u , π , n ) = f ( u , {g}_{1} ( u , n ) , n ) {=}^{Δ} {f}_{1} ( u , n ) . \qquad ( 11 )$$

Then, the nonlinear expression for the speed and pressure ratio is the following:

$$\{ \begin{matrix}n = {f}_{1} ( u , n ) \\ π = {g}_{1} ( u , n )\end{matrix} . \qquad ( 12 )$$

Linearize the nonlinear expression to obtain a state variable model

Furthermore, x=Δn=n−nₑ, and y=Δπ=π−πₑ.

$$A = \frac{\partial {f}_{1}}{\partial x} , B = \frac{\partial {f}_{1}}{\partial u} \\ C = \frac{\partial {g}_{1}}{\partial x} , D = \frac{\partial {g}_{1}}{\partial u} \qquad ( 14 )$$

At an equilibrium point,

$$\{ \begin{matrix}0 = {f}_{1} ( u , {x}_{e} ) \\ {y}_{e} = {g}_{1} ( u , {x}_{e} )\end{matrix} ⇒ \{ \begin{matrix}{x}_{e} {=}^{Δ} {f}_{e} ( u ) \\ {y}_{e} = {g}_{1} ( u , f ( u ) ) {=}^{Δ} {g}_{e} ( u )\end{matrix} , \qquad ( 15 )$$

wherein the subscript e represents the data at a steady-state point.

A coefficient matrix is obtained with the small perturbation method:

$$\begin{matrix}A = {[ {\dot{x}}^{1} , {\dot{x}}^{2} ] [ {x}^{1} , {x}^{2} ]}^{- 1} , B = - A \frac{{df}_{e}}{du} \\ C = {[ {y}^{1} , {y}^{2} ] [ {x}^{1} , {x}^{2} ]}^{- 1} , D = \frac{d {g}_{e}}{du} - C \frac{{df}_{e}}{du} ,\end{matrix} \qquad ( 16 )$$

wherein (\dot{x}¹, x¹, y¹), (\dot{x}², x², y²) represent nonequilibrium-state data after two different perturbations, the superscript 1 represents the speed of a perturbed low-pressure rotor, and the superscript 2 represents the speed of a high-pressure rotor.

$$\frac{{df}_{e}}{du} \approx \frac{{f}_{e} ( u + Δ u ) - {f}_{e} ( u )}{Δ u} \\ \frac{d {g}_{e}}{du} \approx \frac{{g}_{e} ( u + Δ u ) - {g}_{e} ( u )}{Δ u} \qquad ( 17 )$$

A large number of state variable models form an LPV model

$$\{ \begin{matrix}\dot{x} = A ( θ ) x + B ( θ ) u \\ y = C ( θ ) x + D ( θ ) u\end{matrix} , θ = {[ {n}_{H} , {A}_{8} , H , Ma ]}^{T} , \qquad ( 18 )$$

Different throat sectional areas A8 of the engine and a large number of state variable models at different high-pressure speeds make up an LPV model for speed and pressure ratio, the matrix coefficients are fitted with polynomial, and finally polynomial coefficients are stored.

At a ground operating point, the LPV model is established with different throat areas, and then the application scope of the model is expanded within the envelope by using a similarity theory, wherein the subscript cor represents similarity conversion

$$\{ \begin{matrix}{\dot{x}}_{cor} = {A}_{i} ( {n}_{H} ) {x}_{cor} + {B}_{i} ( {n}_{H} ) {u}_{cor} \\ {y}_{cor} = {C}_{i} ( {n}_{H} ) {x}_{cor} + {D}_{i} ( {n}_{H} ) {u}_{cor}\end{matrix} , {A}_{8} = {A}_{8 i} . \qquad ( 19 )$$

k-order polynomial fitting is performed on each element pair n_{H} in the matrix

p(θ)=Σᵢ₌₀^{k}pᵢθⁱ, i=0, 1, 2, . . . , k (20),

wherein p(θ) represents the polynomial about θ, θ indicates an object to be fitted, θⁱ represents the i-th power of θ, and pᵢ indicates the corresponding polynomial coefficient of θⁱ.

In step A2), a matching relationship in a system of rotor acceleration equations of the engine is established by using the state transition equation in the LPV model, and a balance relationship between a flow rate and a pressure is established by using a system of output parameter equations.

In step A2.1), high-pressure and low-pressure rotor speeds are acquired by matching the state transition equation in the LPV model with the rotor acceleration equation in the co-working equations

$$\begin{matrix}\frac{{dn}_{L}}{dt} = \frac{900 ( {N}_{LT} {η}_{L} - {N}_{F} )}{{π}^{2} {J}_{L} {n}_{L}} \\ \frac{{dn}_{H}}{dt} = \frac{900 ( {N}_{HT} {η}_{H} - {N}_{ex} - {N}_{C} )}{{π}^{2} {J}_{H} {n}_{H}}\end{matrix} \} ⇐ {\dot{x}}_{cor} = {A}_{i} ( {n}_{H} ) {x}_{cor} + {B}_{i} ( {n}_{H} ) {u}_{cor} . \qquad ( 21 )$$

In step A2.2), a pressure ratio among respective rotating components is acquired by establishing the balance relationship between the flow rate and the pressure in the co-working equations with the output parameter equations in the LPV model.

$$\{ \begin{matrix}( Single - bypass mode ) {e}_{1} = \frac{( {W}_{a 12} + {W}_{a 23} )}{{W}_{a 2} - 1} \\ ( Double - bypass mode ) {e}_{1} = \frac{{P}_{s 114}}{{P}_{s 224} - 1} \\ \begin{matrix}{e}_{2} = \frac{{W}_{g 41}}{{W}_{g 4} - 1} \\ {e}_{3} = \frac{{W}_{g 44}}{{W}_{g 43} - 1} \\ {e}_{4} = \frac{{W}_{g 9}}{{W}_{g 7} - 1} \\ {e}_{5} = \frac{{P}_{s 16}}{{P}_{s 6} - 1}\end{matrix}\end{matrix} \} ⇐ {y}_{cor} = {C}_{i} ( θ ) {x}_{cor} + {D}_{i} ( θ ) {u}_{cor} \qquad ( 22 )$$

In step A3), a non-iterative solution to the co-working equations for the speed and pressure ratio is found by the LPV model.

The stored polynomial coefficients are loaded to compute the elements in the coefficient matrix, thereby obtaining each coefficient matrix. Through the LPV model for the speed and pressure ratio, the speed and pressure ratio in the current state are further computed,

$$( 23 )$$

$$\{ \begin{matrix}{a}_{ij} = {p}_{a , 3}^{ij} {n}_{H}^{3} + {p}_{a , 2}^{ij} {n}_{H}^{2} + {p}_{a , 1}^{ij} {n}_{H} + {p}_{a , 0}^{ij} , i = 1 , 2 j = 1 , 2 \\ {b}_{ij} = {p}_{b , 3}^{ij} {n}_{H}^{3} + {p}_{b , 2}^{ij} {n}_{H}^{2} + {p}_{b , 1}^{ij} {n}_{H} + {p}_{b , 0}^{ij} , i = 1 , 2 j = 1 \\ {c}_{ij} = {p}_{c , 3}^{ij} {n}_{H}^{3} + {p}_{c , 2}^{ij} {n}_{H}^{2} + {p}_{c , 1}^{ij} {n}_{H} + {p}_{c , 0}^{ij} , i = 1 , 2 , … 5 j = 1 , 2 \\ {d}_{ij} = {p}_{d , 3}^{ij} {n}_{H}^{3} + {p}_{d , 2}^{ij} {n}_{H}^{2} + {p}_{d , 1}^{ij} {n}_{H} + {p}_{d , 0}^{ij} , i = 1 , 2 , … 5 j = 1\end{matrix} ,$$

wherein i and j represent the column and row of the element in the matrix. From each element in the coefficient matrix of the equation (23), the coefficient matrix A, B, C and D at the current high-pressure speed n_{H} can be obtained, and the speed and the pressure ratio of each component can be solved by the LPV model through computation as the following:

$$\begin{matrix}\{ \begin{matrix}\dot{x} = Ax + Bu \\ y = Cx + Du\end{matrix} & ( 24 ) \\ \{ \begin{matrix}n = Δ n + {n}_{e} = \dot{x} \cdot Δ t + {n}_{e} \\ π = Δ π + {π}_{e} = y + {π}_{e}\end{matrix} . & ( 25 )\end{matrix}$$

Then, interpolation is performed according to the current A8 to compute the speed and pressure ratio under the current throat sectional area A8,

$$\{ \begin{matrix}n = {n}_{i} + ( {n}_{i + 1} - {n}_{i} ) ( A 8 - A {8}_{i} ) / ( A {8}_{i + 1} - A {8}_{i} ) \\ π = {π}_{i} + ( {π}_{i + 1} - {π}_{i} ) ( A 8 - A {8}_{i} ) / ( A {8}_{i + 1} - A {8}_{i} )\end{matrix} , \\ A {8}_{i} \leq A 8 \leq A {8}_{i + 1} . \qquad ( 26 )$$

Step B) includes the following steps in detail.

In step B1), a component-level non-iterative model in the single-bypass and double-bypass modes is constructed by combining an existing engine component model with the established model in the LPV form and putting the solved speed and pressure ratio into the computation of each component.

In step B1.1), a current operating mode of the variable-cycle engine is determined based on input parameters.

In step B1.2), a component-level non-iterative model in the single-bypass and double-bypass modes is constructed by loading a corresponding model in the LPV form based on the current operating mode of the variable-cycle engine.

In step B2), the inertia element of output parameters is introduced during the switching of modes to reduce output errors of the model during the switching between the single-bypass and double-bypass modes, with a first-order inertia element expressed in an equation as the following:

$$G ( s ) = \frac{1}{1 + Ts} , \qquad ( 27 )$$

wherein T represents a time constant of the first-order inertial element.

In step B3), a corresponding form of the LPV model is determined based on an operating mode of the variable-cycle engine and system parameters in the LPV form are scheduled with the A8 variable polycell method, thereby implementing non-iterative computation for the airborne real-time model of the variable-cycle engine in different modes, with the form of A8 variable polycell as the following.

In step B3.1), a variation range of A8 for the variable-cycle engine in the single-bypass and double-bypass modes is determined:

$$\{ \begin{matrix}A {8}_{min}^{1} \leq A {8}^{1} \leq A {8}_{max}^{1} , & single - bypass \\ A {8}_{min}^{2} \leq A {8}^{2} \leq A {8}_{max}^{2} , & double - bypass\end{matrix} , \qquad ( 28 )$$

wherein the subscript min represents the minimum value, max represents the maximum value, the superscript 1 represents single-bypass, and the superscript 2 represents double-bypasses.

In step B3.2), the A8 variable polycell method in the single-bypass and double-bypass modes is developed by selecting interpolation points of A8 in different modes based on the determined variation range of A8.

$$A 8 = \{ \begin{matrix}[ A {8}_{1}^{1} , … A {8}_{s}^{1} ] , & single - bypass \\ [ A {8}_{1}^{2} , … A {8}_{s}^{2} ] , & double - bypass\end{matrix} \qquad ( 29 )$$

To verify the effectiveness of the method for component-level non-iterative construction of the airborne real-time model of the variable-cycle engine as designed by the present invention, simulations were performed in a simulation environment of a 64-bit Windows 10 operating system, a host was configured with Intel® Core™ i5-5200u CPU @ 2.20 GHz and RAM 8 GB, and the following digital simulations were performed under MATLAB R2016b software.

First, in the single-bypass mode, the state variable model for the speed and pressure ratio, i.e., the coefficient matrix A, B, C and D, of the variable-cycle engine at different high-pressure speeds at a ground point (H=0 m, Ma=0) with A8=[1, 1.05, 1.10, 1.15, 1.20, 1.25] were computed respectively; and 3 polynomial fittings were performed on the corresponding elements of the coefficient matrix at different high-pressure speeds, to obtain the polynomial fitting coefficients of the matrix elements A, B, C and D at different A8s and different high-pressure speeds in the single-bypass mode. In the double-bypass mode, the state variable model for the speed and pressure ratio, i.e., the coefficient matrix A, B, C and D, of the variable-cycle engine at three working points (H=0 m, Ma=0; H=5000 m, Ma=0.6; and H=8000 m, Ma=0.8) with A8=[1.05, 1.10, 1.15, 1.20, 1.25, 1.30] was computed respectively; and 3 polynomial fittings were performed on the corresponding elements of the coefficient matrix at different high-pressure speeds, to obtain the polynomial fitting coefficients of the matrix elements A, B, C, D at different A8s and different high-pressure speeds in the double-bypass mode.

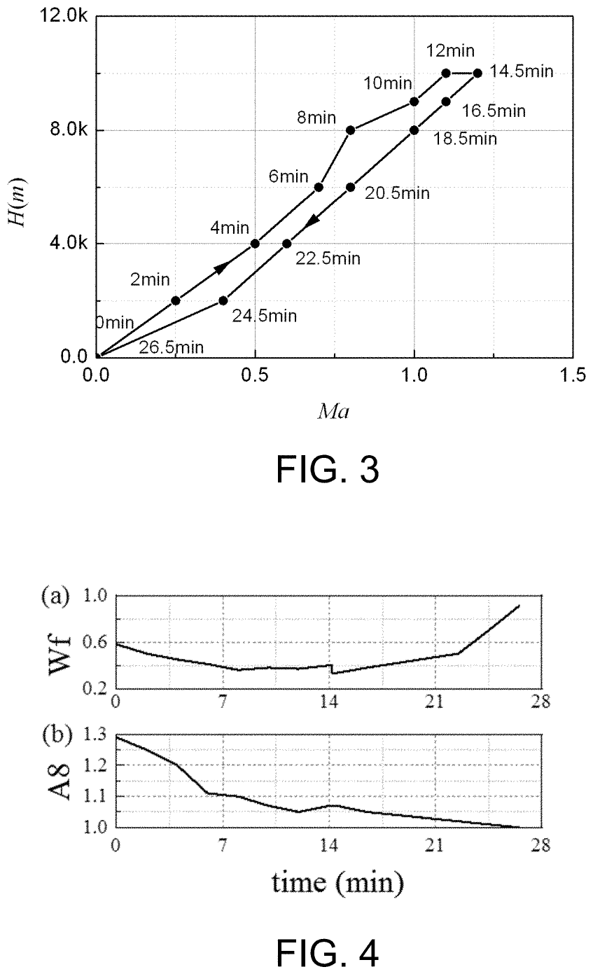

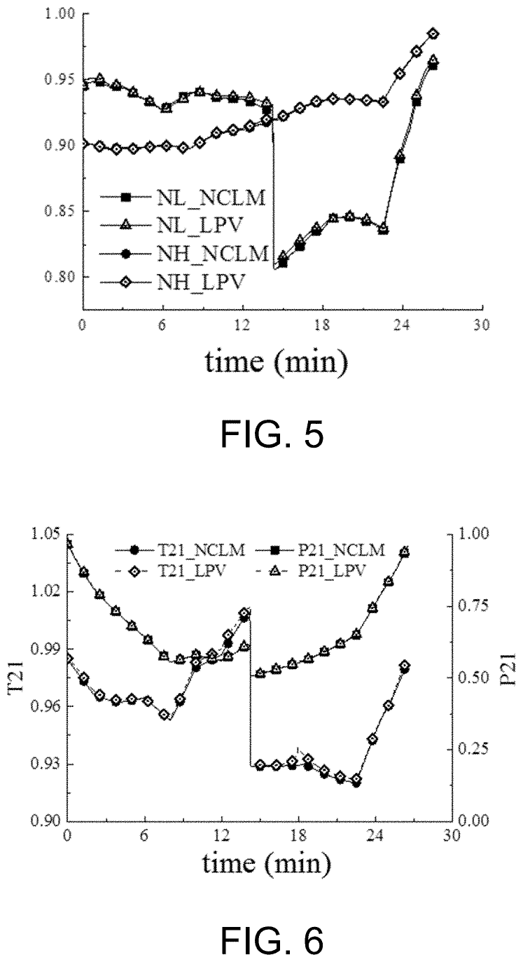

At a ground point (H=0 m, Ma=0), the polynomial fitting coefficients in the double-bypass mode were loaded for taking-off in the double-bypass mode; 0-5,000 m was similarly converted to an operating point (H=0 m, Ma=0), 5,000 m-8,000 m was similarly converted to an operating point (H=5,000 m, Ma=0.6), and those above 8,000 mm were similarly converted to an operating point (H=8,000 m, Ma=0.8); the mode was switched to the single-bypass mode when flight to (H=10,000 m, Ma=1.2), after which the polynomial fitting coefficients in the single-bypass mode were loaded; and then after the flight back to the ground point, a flight trajectory within an envelope was as shown in FIG. 3, the normalized variations of a fuel flow rate W_{f} and an exhaust-nozzle throat sectional area A8 was shown in FIG. 4; and digital simulation verification was performed for this flight cycle.

The measurement parameters of the variable-cycle engine were selected as follows: low-pressure rotor speed NL; high-pressure rotor speed NH; total temperature T21 and total pressure P21 posterior to the fan; total temperature T15 and total pressure P15 for the section of the bypass 15; total temperature T3 and total pressure P3 posterior to the air compressor; and total temperature 15 and total pressure P5 posterior to the low-pressure turbine.

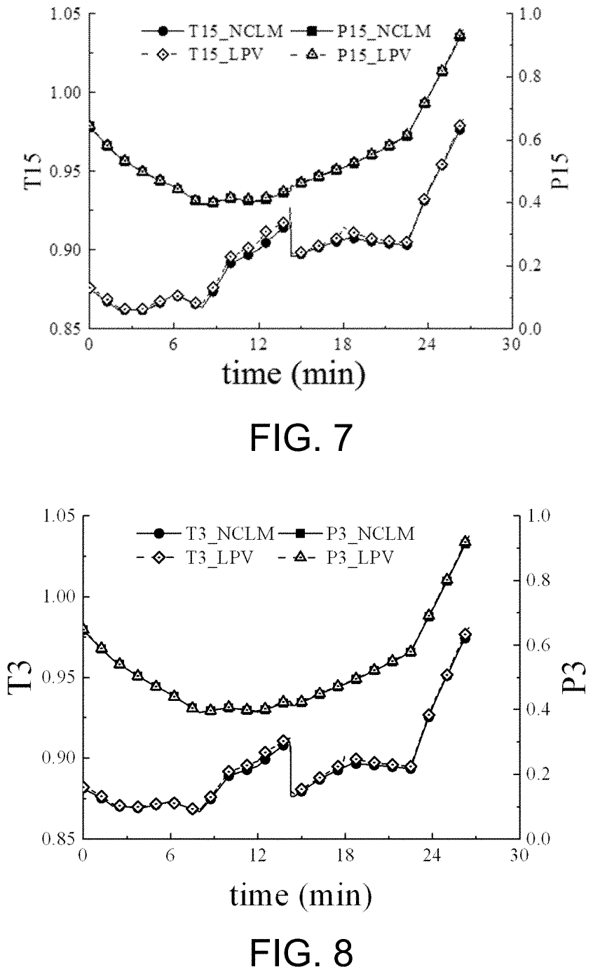

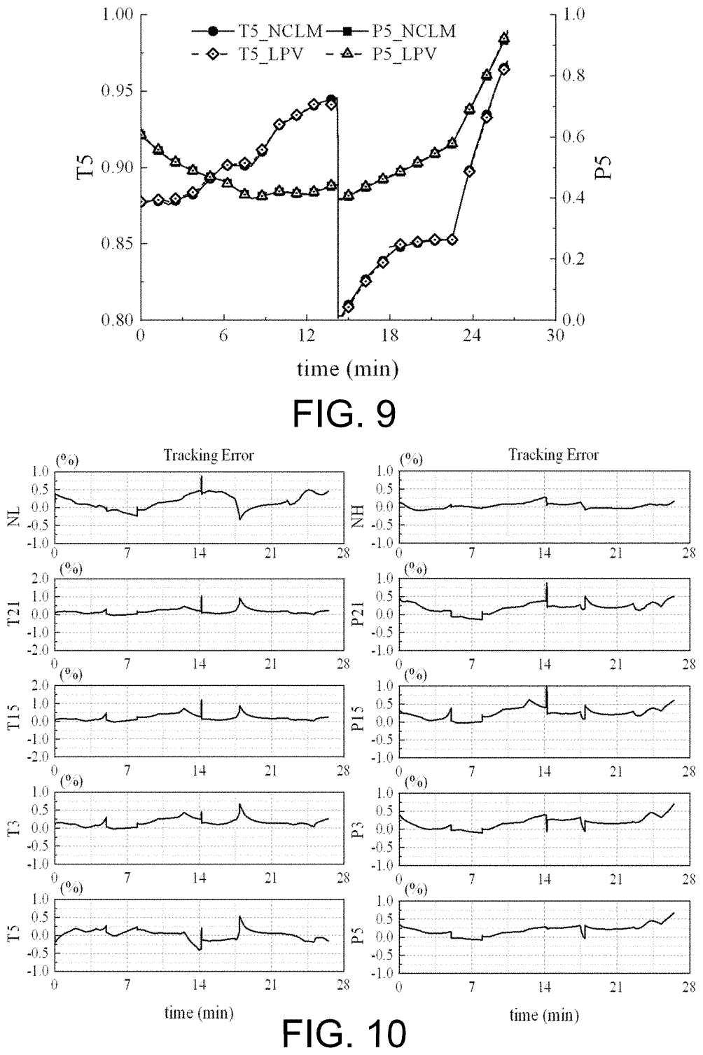

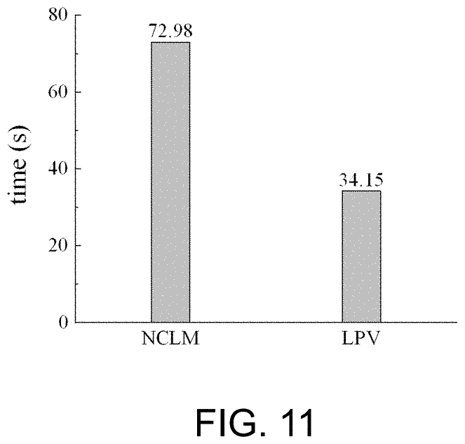

In the diagrams showing the simulation comparison between the component-level non-iterative model and nonlinear component-level model with respect to the output parameters of the engine as shown in FIGS. 5-9, it can be seen from the simulation diagram of output parameters that the component-level non-iterative model better tracks the output of the nonlinear component-level model during the whole flight. From FIG. 10 which shows tracking errors of respective output parameters, it can be seen that the maximum tracking error of each measurement parameter is within 1%, wherein large errors occur only during the mode switching of the engine at the 14^{th} min and at demarcation points of piecewise polynomial fitting at the 17.5^{th} min, and the tracking errors in other cases are basically within 0.5%, which indicates that the component-level non-iterative model has higher accuracy. From FIG. 11 which shows the comparison of simulation time consumption between the nonlinear component-level model and the component-level non-iterative model, it can be seen that the time consumed by the nonlinear component-level model is two times more than that consumed by the component-level non-iterative model. Based on the above simulation results, this method achieves the goal of obtaining a model with higher real-time performance under low accuracy loss.

The description above only provides preferred embodiments of the present invention. It should be noted that for those of ordinary skills in the art, various improvements can be made without departing from the principle of the present invention and shall be construed as falling within the protection scope of the present invention.

1. A method for component-level non-iterative construction of an airborne real-time model of a variable-cycle engine, comprising the following steps:
A) solving state parameters such as speed and pressure ratio of the engine by designing a non-iterative solving algorithm for a system of nonlinear co-working equations in an linear parameter varying (LPV) form based on a component-level model of a variable-cycle engine, wherein a matching relationship of a system of rotor acceleration equations is established by using an LPV state transition equation, and a component-level flow rate balance relationship is established by using a system of LPV output equations; and
B) establishing a component-level non-iterative on-board real-time model of the variable-cycle engine by constructing relationships among component parameters of the variable-cycle engine in a single-bypass mode and a double-bypass mode by using an LPV non-iterative solving method respectively, wherein an inertia element of output parameters is introduced during switching between the single-bypass mode and the double-bypass mode, and an exhaust-nozzle throat area (A8) variable polycell method is used in different modes.

2. The method for component-level non-iterative construction of the airborne real-time model of the variable-cycle engine according to claim 1, wherein the step A) specifically comprises the following steps:
A1) solving matrix coefficients of a state variable model for the speed and the pressure ratio of the variable-cycle engine in different states, to make up an LPV model for the speed and the pressure ratio;
A2) establishing the matching relationship in the system of the rotor acceleration equations of the engine by using the state transition equation in the LPV model, and establishing a balance relationship between a flow rate and a pressure by using a system of output parameter equations; and
A3) finding a non-iterative solution to the system of the nonlinear co-working equations for the speed and the pressure ratio by the LPV model.

3. The method for component-level non-iterative construction of the airborne real-time model of the variable-cycle engine according to claim 1, wherein the step B) specifically comprises the following steps:
B1) constructing the component-level non-iterative model in the single-bypass mode and the double-bypass mode by combining an existing engine component model with the established model in the LPV form;
B2) introducing the inertia element of the output parameters during the switching of the modes to reduce output errors of the model during the switching between the single-bypass mode and the double-bypass mode; and
B3) determining a corresponding form of the LPV model based on an operating mode of the variable-cycle engine and scheduling system parameters in the LPV form with the A8 variable polycell method, thereby implementing non-iterative computation for the airborne real-time model of the variable-cycle engine in different modes.

4. The method for component-level non-iterative construction of the airborne real-time model of the variable-cycle engine according to claim 2, wherein the step A2) specifically comprises the following steps:
A2.1) acquiring high-pressure and low-pressure rotor speeds by matching the state transition equation in the LPV model with the system of the rotor acceleration equations in the system of the nonlinear co-working equations; and
A2.2) acquiring a pressure ratio among respective rotating components by establishing the balance relationship between the flow rate and the pressure in the system of the nonlinear co-working equations with the system of the output parameter equations in the LPV model.

5. The method for component-level non-iterative construction of the airborne real-time model of the variable-cycle engine according to claim 3, wherein the step B1) specifically comprises the following steps:
B1.1) determining a current operating mode of the variable-cycle engine based on input parameters; and
B1.2) constructing the component-level non-iterative model in the single-bypass mode and the double-bypass mode by loading a corresponding model in the LPV form based on the current operating mode of the variable-cycle engine.

6. The method for component-level non-iterative construction of the airborne real-time model of the variable-cycle engine according to claim 3, wherein the step B3) specifically comprises the following steps:
B3.1) determining a variation range of A8 for the variable-cycle engine in the single-bypass mode and the double-bypass mode; and
B3.2) developing an A8 variable polycell method in the single-bypass mode and the double-bypass mode by selecting interpolation points of A8 in different modes based on the determined variation range of A8.
